(19) United States
(12) Patent Application Publication
(10) Pub. No.: US 2013/0208312 A1
(43) Pub. Date: Aug. 15, 2013

(54) MOBILE TERMINAL AND NON-TRANSITORY COMPUTER READABLE MEDIUM STORING PRINT INSTRUCTION PROGRAM

(71) Applicant: Kenichi MORITA, Hino-shi (JP)

(72) Inventor: Kenichi MORITA, Hino-shi (JP)

(73) Assignee: KONICA MINOLTA BUSINESS TECHNOLOGIES, INC., Chiyoda-ku (JP)

(21) Appl. No.: 13/759,095

(22) Filed: Feb. 5, 2013

(30) Foreign Application Priority Data
Feb. 13, 2012 (JP) 2012-027923

(51) Int. Cl. G06F 3/12

(52) U.S. Cl. CPC G06F 3/1285
USPC 358/1.15

(57) ABSTRACT

Provided are a mobile terminal and a non-transitory computer readable medium storing therein a print instruction program. A mobile terminal for instructing one or more printing apparatuses connected to a network to perform printing, includes a touch screen and a control section. The control section is constructed to perform a first process of determining a position or positions of the one or more printing apparatuses viewed from the mobile terminal, and of displaying, on the touch screen, a direction or directions being accompanied with the position or positions of the one or more printing apparatuses; and a second process of, when the control section detects a flick operation on the touch screen along one of the direction or directions, transmitting a print job which gives a print instruction, to one of the one or more printing apparatuses corresponding to the one of the direction or directions.

This application is based on Japanese Patent Application No. 2012-027923 filed on Feb. 13, 2012, in the Japan Patent Office, the entire content of which is hereby incorporated by reference.

### TECHNICAL FIELD

The present invention relates to a mobile terminal and a non-transitory computer readable medium storing a print instruction program. Especially, the present invention relates to a mobile terminal for instructing one or more printing apparatuses connected to a network to perform printing, and a non-transitory computer readable medium storing a print instruction program executed in the mobile terminal.

### BACKGROUND

Printing apparatuses such as a MFP (Multi Function Peripheral) are widespread. In various places such as an office, a printing apparatus is connected to a network, and a user instructs the printing apparatus to perform printing by sending a print job to the printing apparatus from a computer of the user. When plural printing apparatuses are connected to a network, a list of printing apparatuses which are connected to the network is displayed on a screen for displaying print settings of a printer driver, and a user selects a desired printing apparatus among the printing apparatuses displayed in the list and then sends a print job to the printing apparatus to give a print instruction to the same.

As for an example of the print instructions as described above, JP-A No. 2007-133611 discloses a printer control apparatus wherein a printer driver to control printers connected to the printer control apparatus is installed. The printer driver provides users with an operation screen including plural setting items of printing condition which can be selected by users. The printer driver searches printers whose conditions match values of the setting items and arranges the searched result in the operation screen. The printer driver further arranges a user-operable print instruction section in the operation screen for instructing the printers which appear in the searched result to perform a printing process.

In recent years, mobile terminals such as a smart phone and a tablet terminal are widespread, and various manufactures of printing apparatuses have provided printing applications for mobile terminals so that users may instruct printing apparatuses to perform printing from their mobile terminals.

However, even printing applications for mobile terminals can cause the following issues under the condition that plural printing apparatuses are connected to a network. Under the condition, a user is required to select a desired printing apparatus from among printing apparatuses shown in a list and then to instruct the printing apparatus to perform printing, which makes the print instruction less user-friendly. Further, it is not easy for a user to pick up a printing apparatus which is desirable for a user to give print instructions from among printing apparatuses shown in the list, which affects intuitive print instructions. The present invention seeks to solve these problems.

### SUMMARY

There are disclosed an illustrative mobile terminals and a non-transitory computer readable medium storing print instruction program, for instructing a desired printing device to perform printing by user-friendly and intuitive operations.

An illustrative mobile terminal reflecting one aspect of the present invention is a mobile terminal for instructing one or more printing apparatuses connected to a network to perform printing. The mobile terminal comprises a touch screen; and a control section. The control section is constructed to perform a first process of determining a position or positions of the one or more printing apparatuses viewed from the mobile terminal, and of displaying, on the touch screen, a direction or directions being accompanied with the position or positions of the one or more printing apparatuses, and a second process of, when the control section detects a flick operation on the touch screen along one of the direction or directions, transmitting a print job which gives a print instruction, to one of the one or more printing apparatuses corresponding to the one of the direction or directions.

An illustrative non-transitory computer readable medium reflecting one aspect of the present invention is a non-transitory computer readable medium storing therein a print instruction program. The print instruction program causes a mobile terminal which comprises a touch screen and is constructed to instruct one or more printing apparatuses connected to a network to perform printing, to perform: a first step of determining a position or positions of the one or more printing apparatuses viewed from the mobile terminal, and of displaying, on the touch screen, a direction or directions being accompanied with the position or positions of the one or more printing apparatuses; and a second step of, when the mobile terminal detects a flick operation on the touch screen along one of the direction or directions, transmitting a print job which gives a print instruction, to one of the one or more printing apparatuses corresponding to the one of the direction or directions.

Other features of illustrative embodiments will be described below.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1 is a schematic view illustrating a structure of a printing system relating to an example of the present invention;

Each of FIGS. 2A and 2B is a block diagram illustrating a structure of a mobile terminal relating to an example of the present invention;

FIGS. 3A and 3B show a flowchart illustrating operations of a mobile terminal relating to an example of the present invention;

FIG. 4 is a diagram showing an example of a method to determine the position of a printing apparatus;

FIG. 5 is a diagram showing another example of a method to determine the position of a printing apparatus;

FIG. 6 is a diagram showing a method to determine the position of a printing apparatus by using radio field intensity;

Each of FIGS. 7A and 7B is a diagram illustrating an example of a print instruction screen displayed on a mobile terminal relating to the present invention;

Each of FIGS. 8A and 8B is a diagram illustrating another example of a print instruction screen displayed on a mobile terminal relating to the present invention;

Each of FIGS. 9A and 9B is a diagram illustrating another example of a print instruction screen displayed on a mobile terminal relating to the present invention;

Each of FIGS. 10A and 10B is a diagram illustrating an example of a method to give and cancel print instructions by using a print instruction screen displayed on a mobile terminal relating to the present invention;

Each of FIGS. 11A and 11B is a diagram illustrating another example of a method to give and cancel print instructions by using a print instruction screen displayed on a mobile terminal relating to the present invention;

Each of FIGS. 12A and 12B is a diagram illustrating an example of a method to give and cancel print instructions of plural print sets by using a print instruction screen displayed on a mobile terminal relating to the present invention;

Each of FIGS. 13A and 13B is a diagram illustrating another example of a method to give and cancel print instructions of plural print sets by using a print instruction screen displayed on a mobile terminal relating to the present invention; and

FIG. 14 is a diagram illustrating an example of a method to give print instructions by using a print instruction screen displayed on a mobile terminal relating to the present invention.

### DETAILED DESCRIPTION

Illustrative embodiments of mobile terminals and non-transitory computer readable media each storing a print instruction program will be described below with reference to the drawings. It will be appreciated by those of ordinary skill in the art that the description given herein with respect to those figures is for exemplary purposes only and is not intended in any way to limit the scope of potential embodiments may be resolved by referring to the appended claims.

Mobile terminals and non-transitory computer readable media each storing a print instruction program provided as embodiments of the present invention allow users to instruct a desired printing device to perform printing in user-friendly and intuitive operations because of the following features.

As described in the above description about the background, there have been provided printing applications to instruct a printing apparatus to perform printing by using a mobile terminal. However, in an environment that plural printing apparatuses are connected to a network, conventional printing applications require users to select a desired printing apparatus in a screen listing printing apparatuses and succeedingly to give print instructions to the printing apparatus, which causes users' inconvenience such as an increased number of operations and a lack of intuitive selection of a desired printing apparatus.

Therefore, one embodiment of the present invention causes a mobile terminal to determine a position or positions of one or more printing apparatuses viewed from the mobile terminal, and to display, on a screen area of the touch screen (a display including a touch panel composed of a touch sensor), a direction or directions being accompanied with the determined position or positions of the one or more printing apparatuses (preferably, a direction or directions pointing to the position or positions where the one or more printing apparatuses are placed). When a user performs a flick operation (flicking) to flick a finger or a touch pen toward the direction accompanied with the position of a desired printing apparatus, the embodiment causes the mobile terminal to detect the flick operation, and to transmit a print job to the printing apparatus arranged at a place accompanied with the direction, in order to instruct the printing apparatus to perform printing.

Further, when a predetermined finalizing operation (such as an operation to touch a print button which has been provided in advance) is performed after plural flicking operations, the embodiment may cause the mobile terminal to increase the number of times to transmit a print job to the printing apparatus (to increase the number of print sets) corresponding to the number of flicking operations. When a flicking operation is performed toward the opposite direction, the embodiment may cause the mobile terminal to cancel print jobs out or decrease the number of print jobs (decrease the number of print sets).

Thereby, users can get a required numbers of print sets by user-friendly and intuitive operations in short time, when they want to prepare printed matters.

In the method that a user gives print instructions by moving a print job to a desired printing apparatus on a mobile terminal by a drag operation, it is difficult for a user to give print instructions to the printing apparatus displayed outside the display range of the screen area. However, in the method that a flick operation is performed toward the direction accompanied with a printing apparatus as the embodiment of the present invention, a user can give print instructions to a printing apparatus properly even when the printing apparatus is displayed outside the display range and the operability can be enhanced compared with the method using a drag operation.

### Example

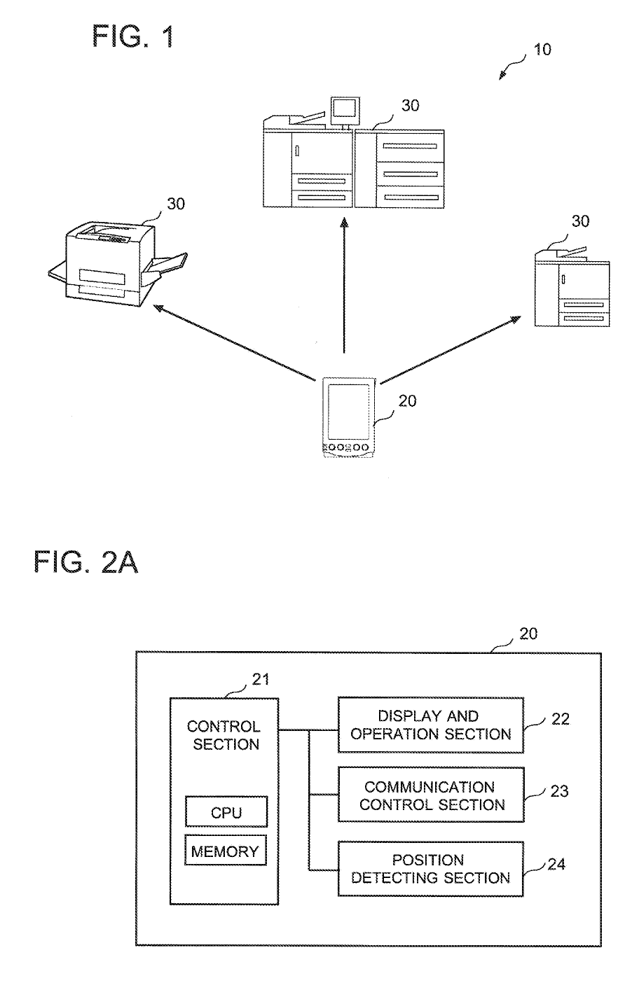

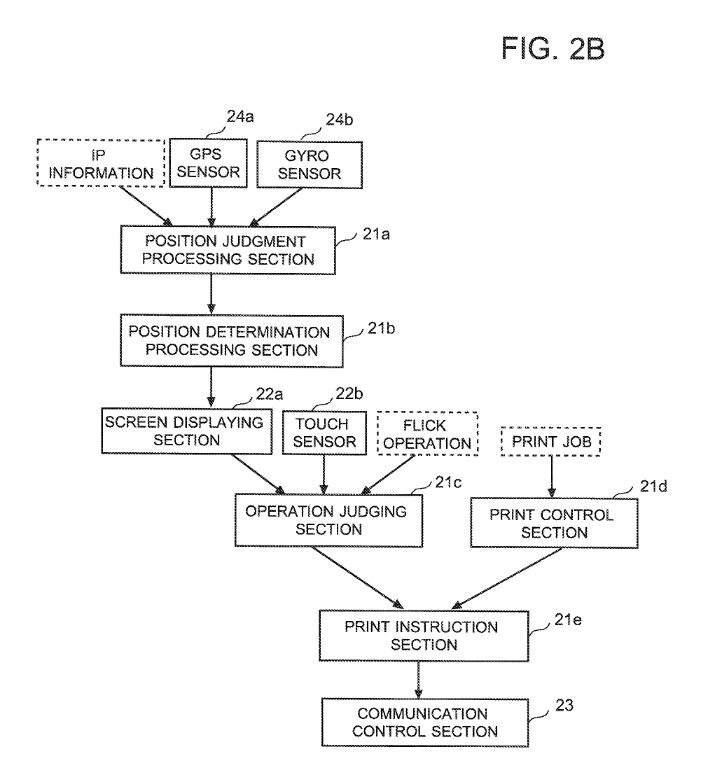

Examples of a mobile terminal and a non-transitory computer readable medium storing a print instruction program will be described with reference to FIGS. 1 to 14, for illustrating the above-described embodiments in detail.

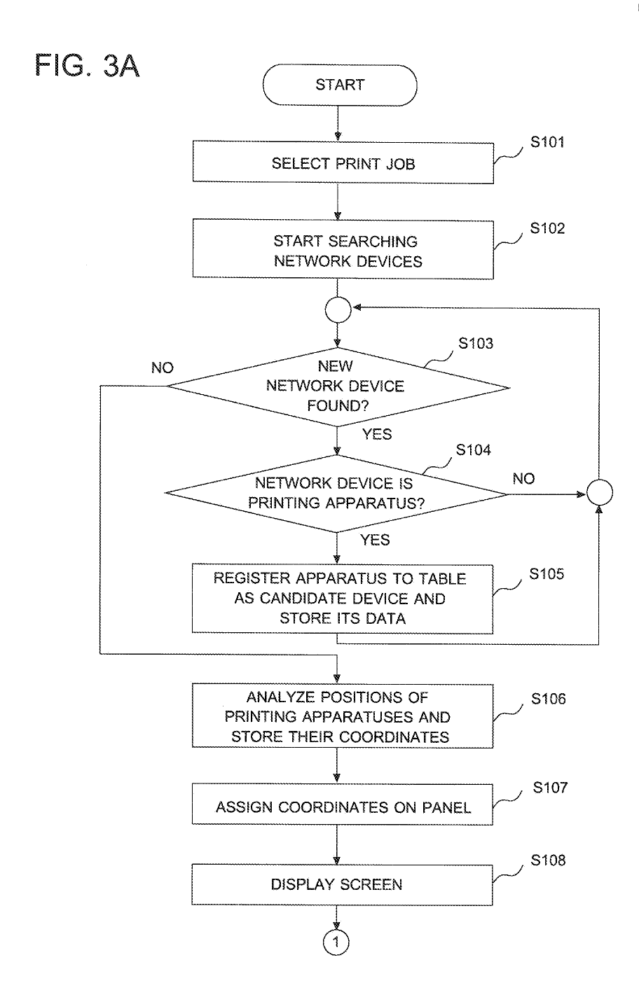

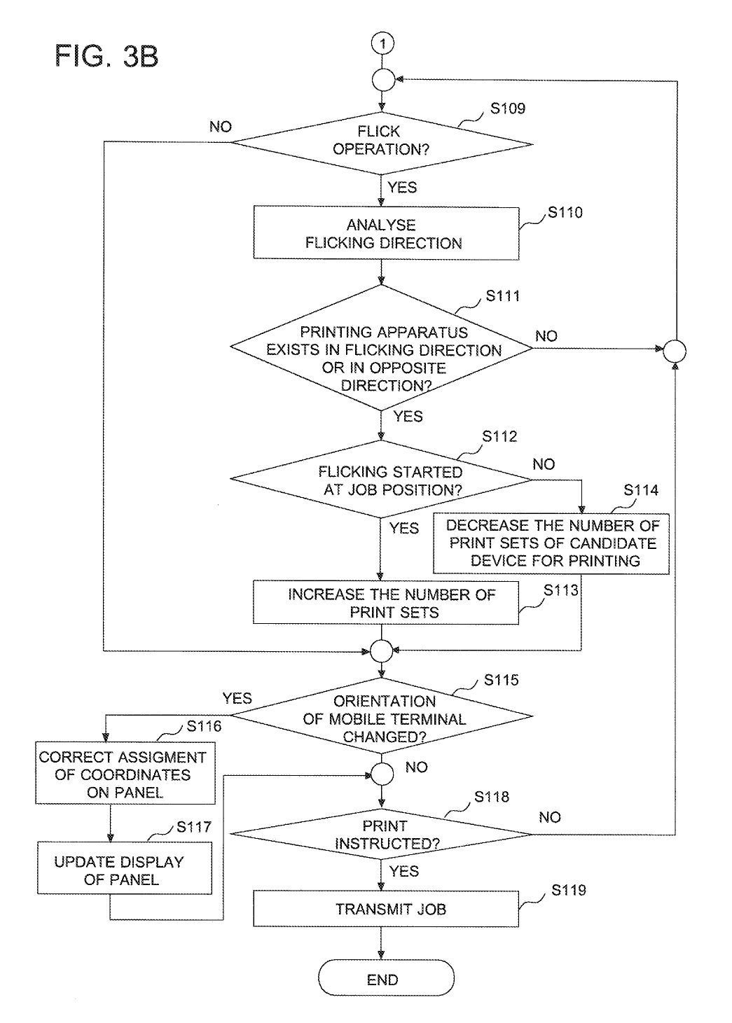

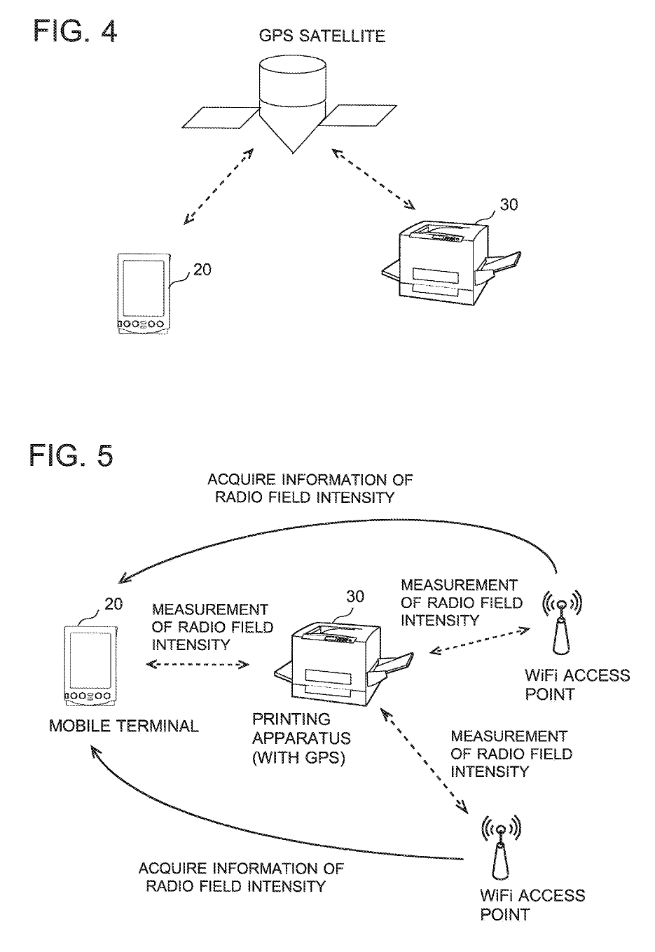

FIG. 1 is a schematic view illustrating a structure of a printing system relating to the present example. Each of FIGS. 2A and 28 is a block diagram illustrating a structure of a mobile terminal relating to the present example. FIGS. 3A and 3B show a flowchart illustrating operations of the mobile terminal. Each of FIGS. 4 to 6 is a diagram showing a method to determine the position of a printing apparatus. FIGS. 7A through 98 are diagrams illustrating examples of a print instruction screen displayed on a mobile terminal relating to the present example. FIGS. 10A through 14 are diagrams illustrating methods to give and cancel print instructions by using the print instruction screen.

In the following descriptions, a flick operation means an operation to make a tip of a finger or a touch pen touch with a predetermined position on a screen and to flick the tip of the finger or the touch pen toward a predetermined direction, which does not include an operation to make a tip of a finger or a touch pen touch with a first position on the screen and move the same to a second position on the screen (a so-called drag operation).

As shown in FIG. 1, printing system 10 of the present example is composed of mobile terminal 20 such as a smart phone, a tablet terminal, a mobile phone, and a notebook-type computer, and at least one printing apparatus 30 such as a MFP or a printer, which are connected to each other through a network such as a LAN (Local Area Network) and a WAN (Wide Area Network). Mobile terminal 20 can instruct one or more printing apparatuses on the network to perform printing. Hereinafter, respective devices will be described by using FIGS. 2A and 2B.

### Mobile Terminal:

As shown in FIG. 2A, mobile terminal 20 is composed of components including control section 21, display and operation section 22, communication control section 23 and position detecting section 24.

Control section 21 is composed of components including a CPU (Central Processing Unit), and a memory including RAM (Random Access Memory) and ROM (Read Only Memory), and controls the entire of mobile terminal 20.

Display and operation section 22 is a touch screen wherein capacitive or pressure-sensitive touch sensor 22b is arranged on screen displaying section 22a such as a LCD (Liquid Crystal Display) and an organic EL (electroluminescence) display. Display and operation section 22 displays a print instruction screen wherein a direction from a predetermined position (a position where a print job is displayed) toward a position accompanied with each printing apparatus 30 is indicated thereon, detects a movement path of a finger or a touch pen on the print instruction screen and outputs the detected result to control section 21.

Communication control section 23 is a communication interface such as a NIC (Network Interface Card) and a modem, and handles communication to each printing apparatus 30 according to standards such as ETHERNET (trademark).

Position detecting section 24 is a device such as GPS (Global Positioning System) sensor 24a and gyro sensor 24b, and is provided for getting information for determining the position and the orientation of mobile terminal 20 and outputting the information to control section 21.

The above control section 21 also works as position judgment processing section 21a, position determination processing section 21b, operation judging section 21c, print control section 21d and print instruction section 21e, by means of a program (a print instruction program) which has been stored in a memory of control section 21 and is executed on the CPU of control section 21.

Position judgment processing section 21a performs the following operations based on the positional information of mobile terminal 20 obtained from GPS sensor 24a, the orientation information of mobile terminal 20 obtained by gyro sensor 24b, and the positional information of each printing apparatus 30. Position judgment processing section 21a determines the position of each printing apparatuses 30 which can output print images based on a print job outputted from mobile terminal 20 by using the method which will be described below, and stores the determined positional information (coordinates) in a memory.

Position determination processing section 21b reads the positional information (coordinates) of each printing apparatus 30 determined by position judgment processing section 21a from the memory, and determines the position of each printing apparatus 30 on screen displaying section 22a based on the position and the orientation of mobile terminal 20. Position determination processing section 21b further makes screen displaying section 22a display a print instruction screen which indicates a direction accompanied with the position of each printing apparatus 30.

Operation judging section 21c determines the vector direction of an operation to flick a tip of finger or a touch pen (a flick operation) based on a movement path of the finger or the touch pen on screen display section 22a, and transmits the number of flick operations and a predetermined finalizing operation (for example, an operation to touch a print button which has been previously provided on screen displaying section 22a) to print instruction section 21e.

Print control section 21d generates a print job described in a language such as PCL (Printer Control Language) and PDL (Page Description Language) and transmits the print job to print instruction section 21e.

Print instruction section 21e makes the print job which has been generated by print control section 21d accompanied with a flick operation which has been determined by operation judging section 21c, and transmits the print job to printing apparatus 30 corresponding to the vector direction of the flick operation through communication control section 23. When a predetermined finalizing operation has been performed after plural flick operations, print instruction section 21e increases the number of times that print instruction section 21e transmits the print job corresponding to the number of the flick operations. When a flick operation in the opposite direction has been performed, print instruction section 21e cancels the print job or the print jobs, or decreases the number of times that print instruction section 21e transmits the print job.

In FIG. 2B, control section 21 is composed of position judgment processing section 21a, position determination processing section 21b, operation judging section 21c, print control section 21d and print instruction section 21e. However, the structure of FIG. 2B is just an example and the structure is enough to be capable of transmitting a print job to printing apparatus 30 corresponding to the vector direction of a detected flick operation.

### Printing Apparatus:

Printing apparatus 30 is composed of components including a control section, display and operation section, a communication control section and a printing section.

The control section is composed of a CPU and memories including RAM and ROM and controls the entire of printing apparatus 30. The control section also works as a job analyzing section which analyzes a print job received from mobile terminal 20, and an image processing section which rasterizes data of respective pages (carries out a bitmap decompression) based on the analyzed result to generate image data.

The display and operation section is a touch screen wherein a touch sensor is arranged on a screen displaying section such as a LCD and an organic EL display. The display and operation section displays various screens for realizing functions such as those of a copier, a scanner, a printer and a facsimile.

The communication control section is a communication interface such as a NIC and a modem, and handles communication to mobile terminal 20 according to standards such as ETHERNET (trademark).

The printing section transfers image data onto paper. Concretely, the printing section performs the following operations. The printing section causes an exposure device to emit light according to an image onto a photoconductor drum which is charged by a charging device, and foil ins electrostatic latent images thereon. The printing section makes toner which is charged by a development device stuck onto the photoconductor drum to perform a development process. The printing section carries out primary transference to transfer the resulting toner image onto a transfer belt, carries out secondary transference to transfer the image from the transfer belt to paper medium, and performs processing to fix the toner image on a paper medium with a fixing device.

Next, operations of mobile terminal 20 in the above structure will be described with reference to the flowchart shown in FIGS. 3A and 3B. Herein, the respective operations of position judgment processing section 21a, position determination processing section 21b operation judging section 21c, print control section 21d, and print instruction section 21e may be realized by a print instruction program which has been stored in a memory of control section 21 and is executed on the CPU of control section 21.

First, control section 21 makes screen displaying section 22a display a screen of a print job list, and makes a user select a print job to be transmitted to printing apparatus 30 (S101).

Alter the user selects a print job, position judgment processing section 21a starts searching devices connected to a network (S102). When detecting a new network device (S103: YES), position judgment processing section 21a judges whether the network device is printing apparatus 30 or not (S104). If the network device is not printing device 30, position judgment processing section 21a takes the operations back to step S103 to search another network device. If the network device is printing device 30, position judgment processing section 21a registers the device into a table as a candidate device for print instructions and stores its data (S105). Then, position judgment processing section 21a takes the operations back to step S103 and searches another network device.

When finishing the search for new network devices (S103: No), position judgment processing section 21a analyzes the position of each printing apparatus 30 and stores positional information (coordinates) of each printing apparatus 30 into a memory (S106). At that time, position judgment processing section 21a determines the position of the mobile terminal itself based on GPS information obtained from GPS sensor 24a, further determines the orientation of the mobile terminal itself based on information obtained from gyro sensor 24b, and also stores the positional information (coordinates) and the orientation information of the mobile terminal itself to a memory. Determining positional information (coordinates) of each printing apparatus 30 and the positional information (coordinates) and the orientation information of the mobile terminal enables to determine the position of each printing apparatus 30 viewed from the mobile terminal.

As a method to analyze the position of each printing apparatus 30, for example, there can be provided an analysis in an absolute coordinate system based on GPS information and an analysis based on electric field intensities measured by three network devices.

As for the former method, for example, each of mobile terminal 20 and printing apparatus 30 receives GPS information from a GPS satellite as shown in FIG. 4, and printing apparatus 30 transmits the received GPS information to mobile terminal 20, which allows mobile terminal 20 to determine the position of printing apparatus 30.

As for the latter method, for example, each of mobile terminal 20 and two WiFi access points (or other mobile terminals 20) whose positions are already known measures the electric field intensity transmitted by printing apparatus 30 as shown in FIG. 5, and each of the two access points (or other mobile terminals 20) transmits information of the measured electric field intensity to the mobile terminal 20, which allows mobile terminal 20 to determine the position of printing apparatus 30 viewed from the mobile terminal 20.

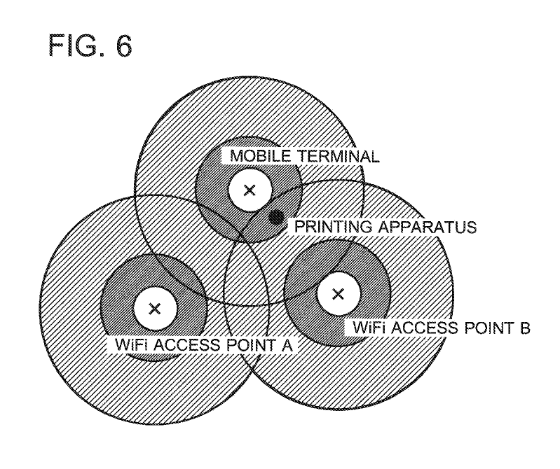

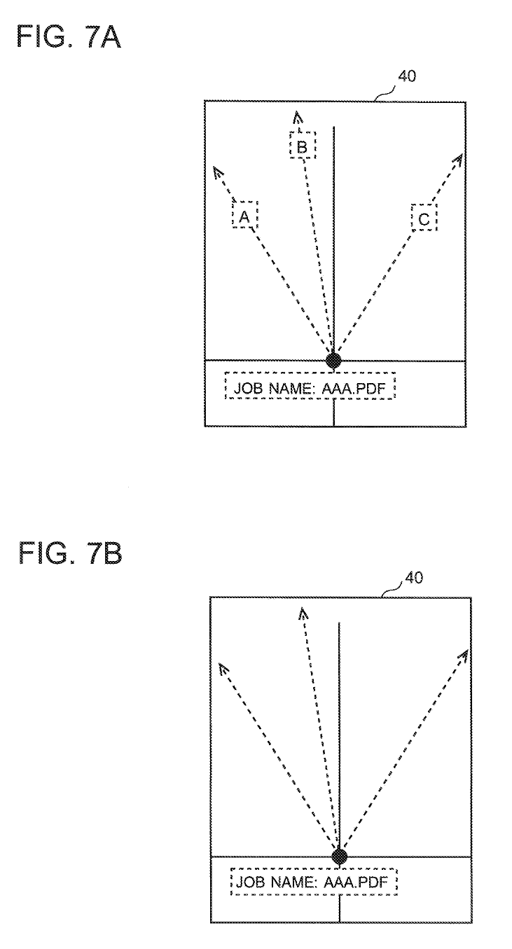

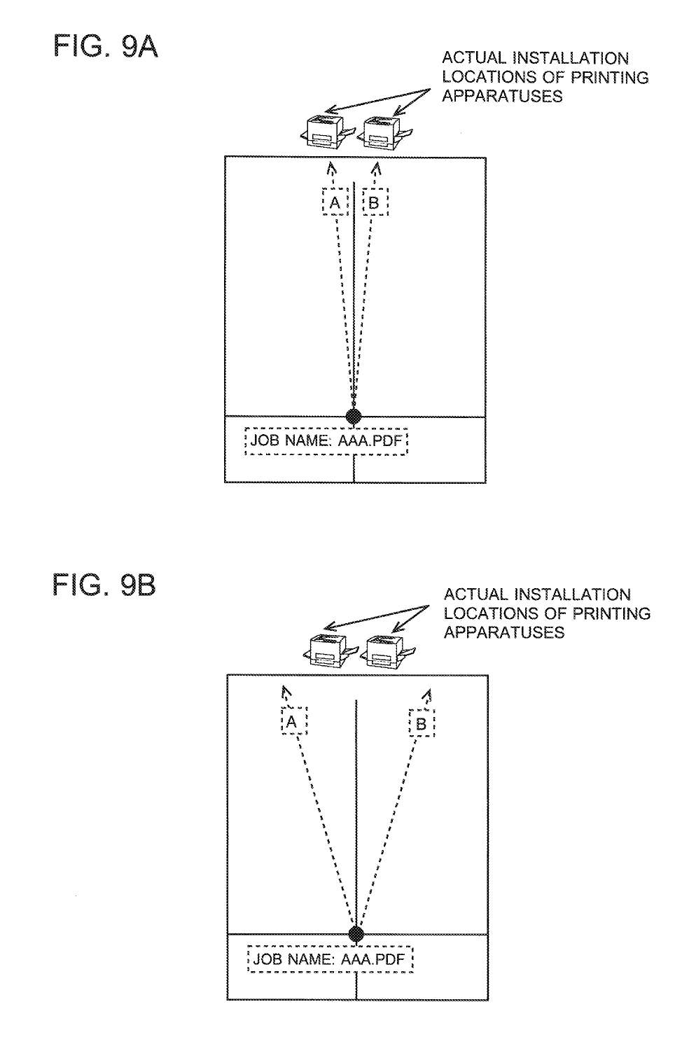

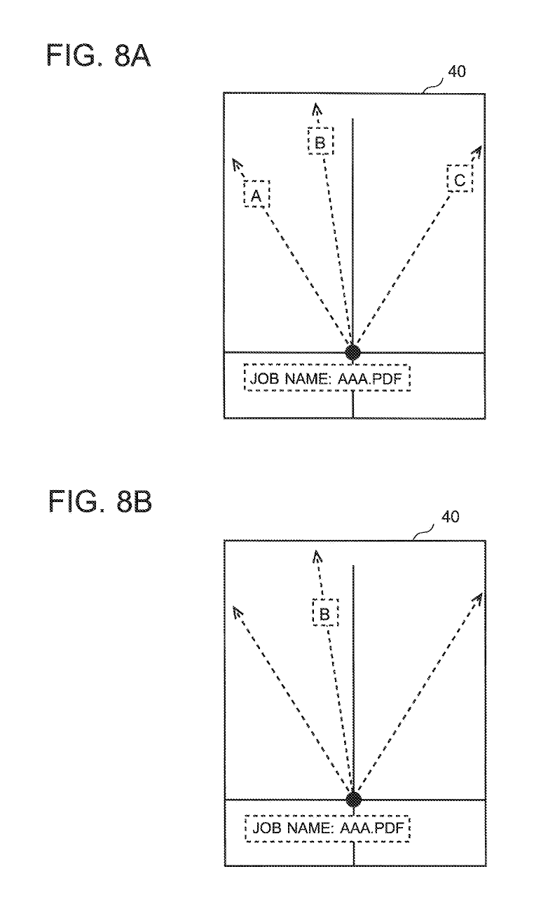

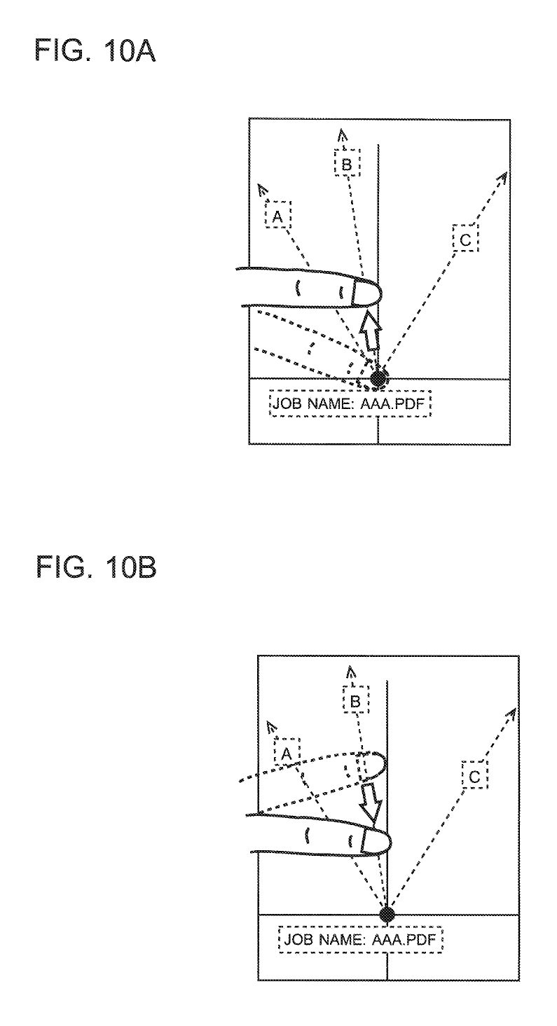

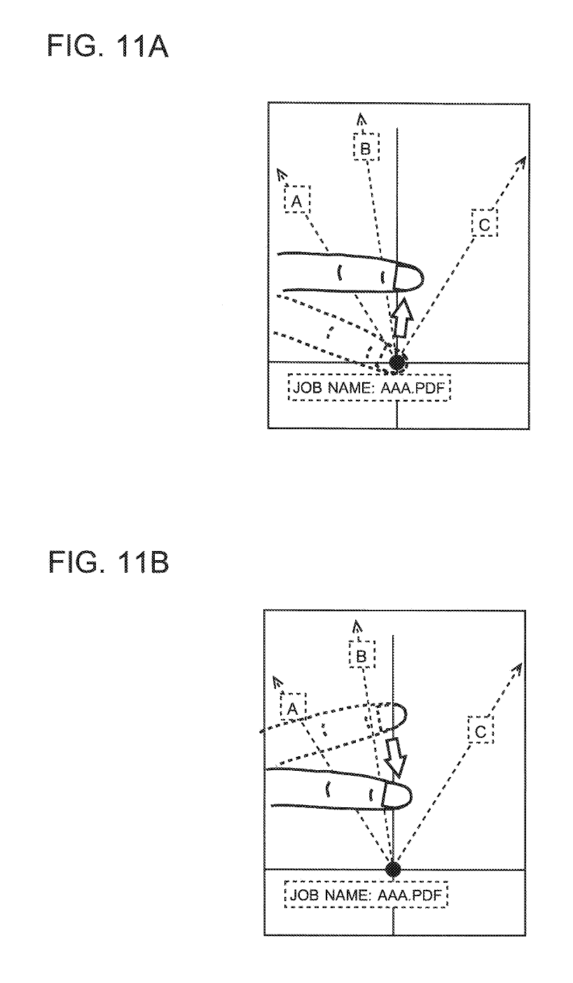

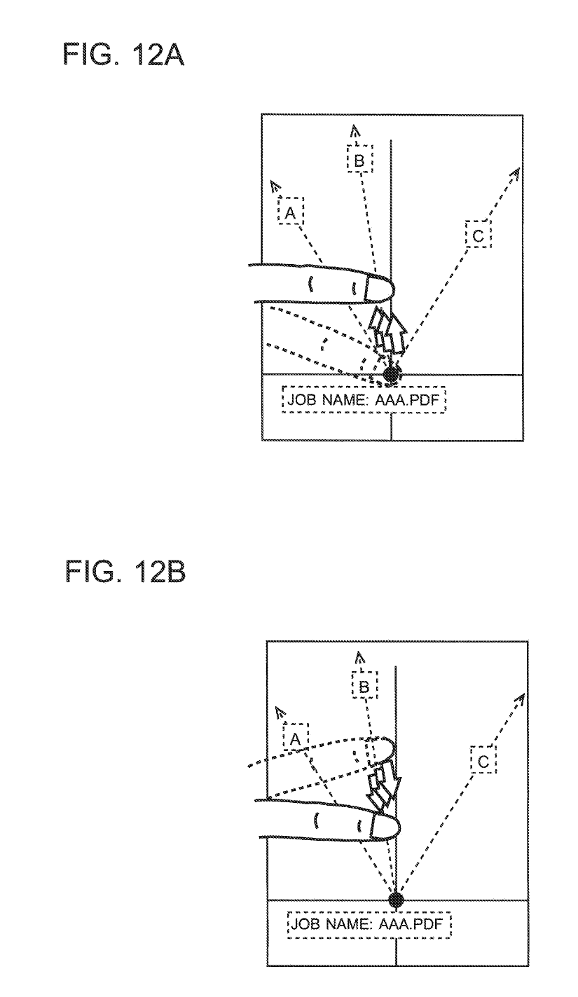

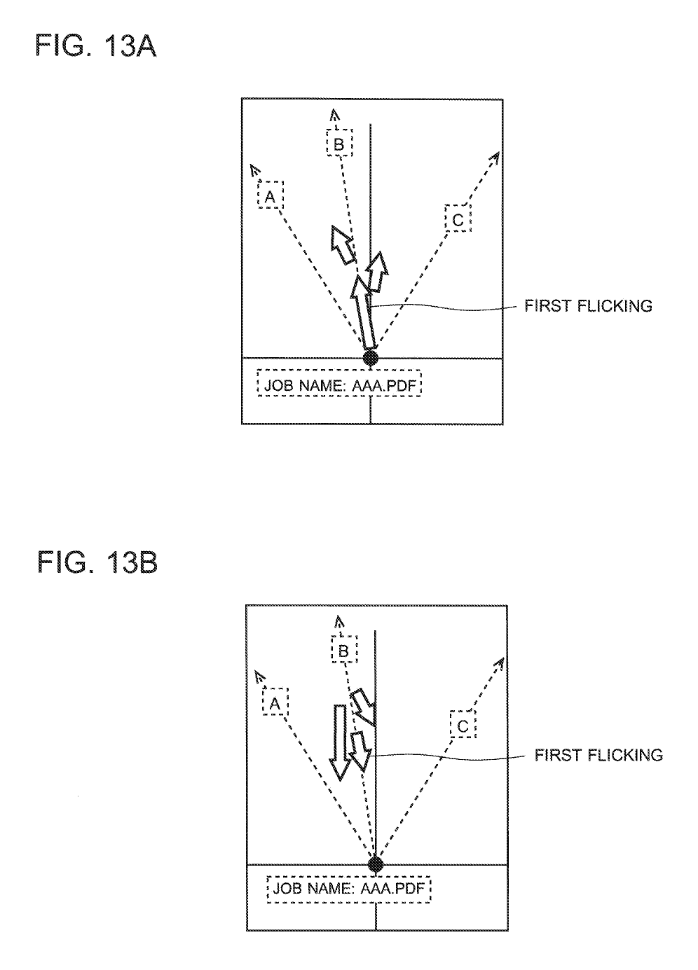

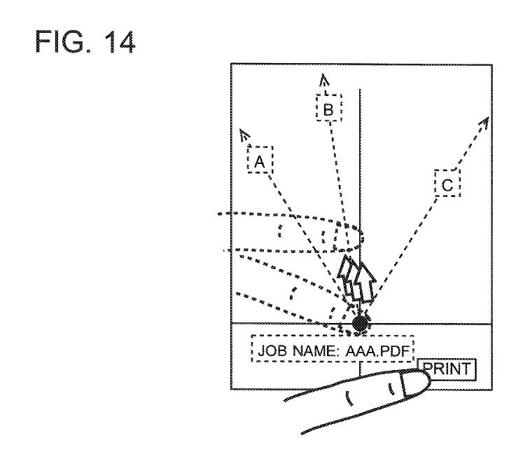

Concretely, as shown in FIG. 6, under the condition that the value of the electric field intensity measured by mobile terminal 20 indicates a position in an area where the electric field intensity is strong (the finely hatched area in FIG. 6), the value of the electric field intensity measured by WiFi access point B indicates a position in an area where the electric field intensity is weak (the roughly hatched area in FIG. 6), and the value of the electric field intensity measured by WiFi access point A indicates a position outside the area where the electric field intensity is weak, mobile terminal 20 can determine the position of printing apparatus 30 viewed from the mobile terminal if mobile terminal 20 has previously got the positions of the three devices of WiFi access points A and B and mobile terminal 20 (or printing apparatus 30).

Returning to the flowchart shown in FIGS. 3A and 3B, position determination processing section 21b assigns coordinates on screen displaying section 22a to each printing apparatus 30 based on the stored positional information (coordinates) of each printing apparatus 30 and the stored positional information (coordinates) and orientation information of the mobile terminal itself (S107), and makes screen displaying section 22a display a print instruction screen indicating the direction accompanied with the position of each printing apparatus 30 thereon (S108).

FIG. 7A shows an example of print instruction screen 40. On print instruction screen 40, there are displayed a figure (the black dot in FIG. 7A) indicating the position of the mobile terminal itself, information determining a print job (JOB NAME in FIG. 7A), lines running from the mobile terminal itself toward printing apparatuses 30 on the network (arrows with broken lines in FIG. 7A), and information determining printing apparatuses 30 (rectangles representing the positions of printing apparatuses 30 and symbols A to C for identifying printing apparatuses 30).

FIG. 7A shows rectangles representing printing apparatuses 30 and symbols A to C for identifying printing apparatuses 30, as information for determining printing apparatuses 30. However, arbitrary information for determining printing apparatuses 30 can be used, such as marks schematically representing printing apparatuses 30 (icons of printers) and product numbers of printing apparatuses 30. Further, FIG. 7A shows information for determining a print job, but it is not required to display the information for determining a print job under the condition that print instruction screen 40 is displayed after selection of a print job.

FIG. 7A displays lines running toward printing apparatuses 30 and the information for determining printing apparatuses 30 on the print instruction screen. However, there may be displayed only lines running toward printing apparatuses 30 as shown in FIG. 7B, because users can make printing apparatuses 30 on the print instruction screen and actual printing apparatuses 30 accompanied with each other easily, by looking around themselves.

In FIG. 7A, the display position of information for determining each printing apparatus 30 is changed corresponding to the distance between mobile terminal 20 and each printing apparatus 30. However, the display position of the information determining each printing apparatus 30 may be displayed without being changed corresponding to the distance between mobile terminal 20 and each printing apparatus 30 as shown in FIG. 8A, because users can make printing apparatuses 30 on the printing instruction screen 40 and actual printing apparatuses 30 accompanied with each other easily as described above. Further, only the information for determining the printing apparatus 30 which is closer to mobile terminal 20 than others may be displayed on the screen as shown in FIG. 8B.

In FIGS. 7A, 7B, 8A and 8B, the directions of arrows are pointing to the installed locations of actual printing apparatuses 30. However, it is enough that the directions of arrows are just accompanied with the positions of printing apparatuses 30. The directions of arrows may be displaced in some degree from the positions where printing apparatuses 30 are actually installed. For example, under the condition that two printing apparatuses 30 are placed to be close together, if the two arrows are displayed to be close together as shown in FIG. 9A, a user can transmit a print job to unwanted printing apparatus 30. In view of that, the two arrows may be displayed to be distant more than the actual situation, as shown in FIG. 9B.

Going back to the flowchart of FIGS. 3A and 3B again, operation judging section 21c monitors a flick operation which flicks a finger or a touch pen, according to signal coming from touch sensor 22b (S109). When a flick operation is not performed, the operations skip to step S115. When a flick operation is performed, operation judging section 21c analyzes the direction of the flick operation (S110). Then, operation judging section 21c judges whether printing apparatus 30 exists along the direction of the flick operation (or the direction opposite to the flick operation for cancelling printing) or not (S111). When printing apparatus 30 does not exist along the direction, operation judging section 21c returns to step S109 and monitors a flick operation.

When printing apparatus 30 exists along the direction of the flick operation or the direction opposite to the flick operation, processing for transmitting a print job which gives a print instruction to printing apparatus 30 accompanied with the direction, will be performed in the following operations. Concretely, operation judging section 21c judges whether the starting point of the flick operation is at the position of a figure representing a print job or not (S112). If the flick operation starts at the position of a figure representing a print job, operation judging section 21c judges the operation as an operation to throw the print job to the printing apparatus and increases the number of print sets (S113). If the flick operation does not start at the position of the figure representing a print job, operation judging section 21c judges the operation as an operation to cancel the print job and decreases the number of print sets (S114).

After that, position judgment processing section 21a judges whether the orientation of mobile terminal 20 has been changed or not, based on information obtained from gyro sensor 24b (S115). If the orientation has been changed, position judgment processing section 21a corrects the assignment of coordinates of each printing apparatus 30 on screen displaying section 22a (S116), and updates display of the print instruction screen shown in FIGS. 7A through 9B (S117).

Then, print instruction section 21e judges whether any printing process has been instructed (for example, whether the number of print sets has been increased or decreased based on the detected flick operation or operations, and whether a predetermined button on screen displaying section 22a has been pushed) (S118). If any printing process has not been instructed, position judgment processing section 21a goes back to step S109 and monitors a flick operation. If a printing process has been instructed, position judgment processing section 21a transmits the print job which has been obtained from printing control section 21d, to printing apparatus 30 as a candidate for instruction, with corresponding to information of the number of print sets obtained from operation judgment section 21c (S119). The printing apparatus 30 prints an instructed number of sets of printed matters.

The above operations will be described in more detail. Herein, it is assumed that three printing apparatuses 30 of printing apparatuses A to C have been searched. For instructing a printing process (throwing a print job) to printing apparatus B under that condition, a user performs a flick operation to flick his or her finger or a touch pen along the arrow pointing the direction of printing apparatus B, starting at the figure (the black dot in FIG. 10A) representing the position of the mobile terminal itself as shown in FIG. 10A. On the other hand, for canceling the print job which has been thrown to printing apparatus B under that condition, a user performs a flick operation to flick his or her finger or a touch pen, starting at an arbitrary position on the line indicating the direction of printing apparatus B, toward the figure (the black dot in FIG. 10B) representing the position of the mobile terminal itself as shown in FIG. 10B.

Because an accurate flick operation is difficult for users at that time, even if the movement path of the finger or touch pen goes off the line indicating the direction of printing apparatus 30 as shown in FIGS. 11A and 11B, it is preferable that operation judging section 21c judges the operation as a print instruction (or canceling of a print instruction) to printing apparatus 30 corresponding to the line closest to the movement path of the finger or touch pen or the direction closest to the direction pointed by the movement path (printing apparatus B in this example). Further, if the starting point is displaced from the figure representing the position of the mobile terminal itself, it is preferable that operation judging section 21c judges the operation as a print instruction to printing apparatus 30 corresponding to the line indicating the direction of printing apparatus 30, as far as the operation starts at an arbitrary point on the line indicating the direction of printing apparatus 30.

For instructing to print or cancel a predetermined number of print sets a user performs flick operations a predetermined number of times along the line representing the direction of printing apparatus 30 (printing apparatus B in this example) as shown in FIGS. 12A and 12B. At that time, all the flick operations are preferably performed along the line representing the direction of printing apparatus 30. Alternatively, when the first flick operation is performed along the line representing the direction of printing apparatus 30, operation judging section 21c may judges the succeeding flick operations as operations to the printing apparatus 30 (printing apparatus B in this example) regardless the direction of the succeeding flick operations as shown in FIGS. 13A and 13B, and may increase or decrease the number of print sets. Each of FIGS. 12A and 13A shows an example instructing to perform printing plural print sets. Each of FIGS. 12B and 13B shows an example instructing to cancel printing of plural print sets. Alternatively, a user can perform instructions wherein various types of instructions are mixed, for example, such that a flick operation is performed toward the direction opposite to printing apparatus 30 after a flick operation is performed toward the direction to printing apparatus 30.

Further, when a user is giving print instructions of plural numbers of print sets, operation judging section 21c does not know when to transmit printing jobs. Therefore, as shown in FIG. 14, screen displaying section 22a may display a button for performing print instruction thereon (the print button in FIG. 14), or mobile terminal 20 may include a hardware key arranged thereon, so that operation judging section 21c can transmit the print jobs when detecting touching the button or pressing the key as a finalizing operation.

As described above, by displaying the direction or directions accompanied with one or more printing apparatuses 30 connected to a network on a touch screen of mobile terminal 20, and by detecting an operation to flick a finger or a touch pen (a flick operation) toward the direction accompanied with a desired printing apparatus 30 or the opposite direction, and transmitting or canceling a print job to printing apparatus 30 arranged at the position accompanied with the direction of the operation, with corresponding to the operation, users can make a print instruction with user-friendly and intuitive operations. Further, by preparing print jobs corresponding to the number of times of flick operations, the number of print sets (the number of transmission of print jobs) is changed, which enhances the operability of printing processing.

While the present example of the present invention have been described using specific terms, such description is for illustrative purpose only, and it is to be understood that changes and variations may be made without depending from the spirit or scope of the appended claims.

For example, in the above example, print instruction screen 40 changes its display when the orientation of mobile terminal 20 (the orientation of screen displaying section 22a) has been changed. However, when a user operates mobile terminal 20 with having the mobile terminal in hand, the orientation of the mobile terminal 20 easily changes. If print instruction screen 40 changes its display during the user's operations of screen displaying section 22a, a user can instruct undesired printing apparatus 30 to perform printing. Therefore, print instruction screen 40 may be configured not to change its display till a print job is transmitted, if once a flick operation is detected.

Further, the above examples have been described by using print instructions to printing apparatuses 30. However, it is similarly applicable to instructions other than print instructions to devices other than printing apparatus 30, such as data transmission instructions to a computer device, and image data transmission instructions to a mobile terminal such as a mobile phone and a tablet terminal.

1. A mobile terminal for instructing one or more printing apparatuses connected to a network to perform printing, the mobile terminal comprising:
a touch screen; and
a control section constructed to perform
a first process of determining a position or positions of the one or more printing apparatuses viewed from the mobile terminal, and of displaying, on the touch screen, a direction or directions being accompanied with the position or positions of the one or more printing apparatuses, and
a second process of when the control section detects a flick operation on the touch screen along one of the direction or directions, transmitting a print job which gives a print instruction, to one of the one or more printing apparatuses corresponding to the one of the direction or directions.

2. The mobile terminal of claim 1, wherein
in the second process, the job is generated with corresponding to the number of flick operations detected on the touch screen, to change the number of print sets.

3. The mobile terminal of claim 2, wherein
in the second process, under a condition that a direction of one of the flick operations is pointing to a direction toward the one of the one or more printing apparatuses, the control section increases the number of times that the control section transmits the print job, and
under a condition that a direction of one of the flick operations is pointing to a direction opposite to the direction toward the one of the one or more printing apparatuses, the control section reduces the number of times that the control section transmits the print job.

4. The mobile terminal of claim 2, wherein
in the second process, when the control section detects a predetermined finalizing operation after the flick operations, the control section starts transmitting the print job.

5. A non-transitory computer readable medium storing therein a print instruction program causing a mobile terminal, which comprises a touch screen and is constructed to instruct one or more printing apparatuses connected to a network to perform printing, to perform:
a first step of determining a position or positions of the one or more printing apparatuses viewed from the mobile terminal, and of displaying, on the touch screen, a direction or directions being accompanied with the position or positions of the one or more printing apparatuses; and
a second step of, when the mobile terminal detects a flick operation on the touch screen along one of the direction or directions, transmitting a print job which gives a print instruction, to one of the one or more printing apparatuses corresponding to the one of the direction or directions.

6. The non-transitory computer readable medium of claim 5, wherein
in the second step, the job is generated with corresponding to the number of flick operations detected on the touch screen, to change the number of print sets.

7. The non-transitory computer readable medium of claim 6, wherein
in the second step, when a direction of one of the flick operations is pointing to a direction toward the one of the one or more printing apparatuses,
the program causing the mobile terminal to increase the number of times that the mobile terminal transmits the print job,
when a direction of one of the flick operations is pointing to a direction opposite to the direction toward the one of the one or more printing apparatuses,
the program causing the mobile terminal to reduce the number of times that the control section transmits the print job.

8. The non-transitory computer readable medium of claim 6, wherein
in the second step, when the mobile terminal detects a predetermined finalizing operation after the flick operations, the program causing the mobile terminal to start transmitting the print job.
